(19) United States
(12) Patent Application Publication
(10) Pub. No.: US 2004/0083157 A1
(43) Pub. Date: Apr. 29, 2004

(54) User interface, system, and method for providing indirect access to construction services

(76) Inventor: James E. Sasser, Houston, TX (US)

Correspondence Address: Gary R. Maze, Duane Morris LLP, Suite 500, One Greenway Plaza, Houston, TX, 77046, US

(21) Appl. No.: 10/386,952

(22) Filed: Mar. 12, 2003

Related U.S. Application Data
(63) Continuation-in-part of application No. 10/281,005, filed on Oct. 25, 2002.

(51) Int. Cl. G06F 17/60

(52) U.S. Cl. 705/37

(57) ABSTRACT

A user interface, system, and method for providing access to construction services are disclosed. In the user interface, a plurality of regions comprise user interface elements useful for setting a construction service context and for providing additional information in the construction service context. Using the user interface, a user can create a plan for construction services and access a construction context sensitive directory of construction services providers where the directory may further comprise a rating for a predetermined set of the providers and an access function to access the provider. It is emphasized that this abstract is provided to comply with the rules requiring an abstract which will allow a searcher or other reader to quickly ascertain the subject matter of the technical disclosure. It is submitted with the understanding that it will not be used to interpret or limit the scope or meaning of the claims.

### CROSS-REFERENCE TO RELATED APPLICATION

The present application is a continuation-in-part of and claims priority from U.S. patent application Ser. No. 10/281,005 filed Oct. 25, 2002.

### FIELD OF INVENTION

The present invention relates to providing access to construction services and materials, and more particularly to a user interface, system, and method useful in providing access to construction services and materials.

### BACKGROUND OF THE INVENTION

Potential consumers of construction services and materials often need to gather information regarding numerous facets of a construction project into one final plan. If the information is not gathered and organized correctly, construction may be delayed, costs may exceed a budgeted or desired amount, or critical steps or materials may be omitted or have to be completed out of sequence.

Products exist by which a potential consumer of construction services may obtain information about or obtain materials for desired construction services. However, these products do not provide a single tool or user interface by which information relevant to a project in a certain geographic area may be gathered, planned, investigated, or selected, or by which a final construction plan may be implemented.

Further, these products do not provide an interface through which a potential consumer may selectively compare ratings on materials and/or labor and/or service providers and/or solicit and obtain information and bids from desired providers of materials and/or labor and/or service providers. These products also do not provide an interface through which a potential provider of construction services may bid, e.g. anonymously, for a construction project from a consumer, e.g. an anonymous consumer.

### BRIEF DESCRIPTION OF THE DRAWINGS

The features, aspects, and advantages of the present invention will become more fully apparent from the following description, appended claims, and accompanying drawings in which:

FIG. 1 is a schematic overview of an exemplary system;

FIG. 2 is a first exemplary display of a user interface;

FIG. 3 is a second exemplary display of a user interface;

FIG. 3a is an alternative exemplary display of a user interface useful for bidding;

FIG. 4 is an exemplary rating display;

FIG. 5 is an exemplary provider questionnaire;

FIGS. 6, 6a, and 6b are an exemplary bid forms;

FIG. 7 is an exemplary project plan chart;

FIG. 8 is a flowchart of a first exemplary method; and

FIGS. 9a and 9b are flowcharts of a second exemplary method.

### DETAILED DESCRIPTION OF THE PREFERRED EMBODIMENT

In general, throughout this description, if an item is described as implemented in software, it can equally well be implemented as hardware.

As used herein, “data” is either singular or plural, as the context requires.

Further, as used herein, a “project plan” may comprise a timeline containing estimated timing, i.e., the time it will take to complete the portion of a construction related project. A project plan may further comprise details such as cost, materials, and labor components. Timelines may further comprise a portion describing one or more “stages” of construction and information relevant to a stage. For example, a stage may include one or more “construction elements,” e.g. a construction step and/or material, which occur before the consumer buys or builds, a construction step and/or material which occurs when construction or foundations are initiated, a construction step and/or material which occurs when structure construction is being accomplished, a construction step and/or material which occurs when an interior construction is being accomplished, a construction step and/or material which occurs when an exterior construction is being accomplished, a construction step and/or material which occurs when construction is in the finishing or completion stage, a construction step and/or material which occurs after construction of the structure is completed, or the like.

Further, as used herein, “construction service context” means a set of functions, activities, resources, and/or materials desired for a construction project or service such as may be related to a new residential construction project, an existing residential construction project, an existing residential maintenance project, a new non-residential construction project, an existing non-residential construction project, an existing non-residential maintenance project, or the like, or a combination thereof. Further, a construction “step” or “construction service context step” may comprise financing, insuring, purchasing real property, surveying, designing, engineering, obtaining information about construction, planning, estimating costs, procuring material, procuring labor, expending labor, or the like, or a combination thereof

As further used herein, “contractor” comprises contractors, subcontractors, contract laborers, contract professionals, and others involved in residential and non-residential construction.

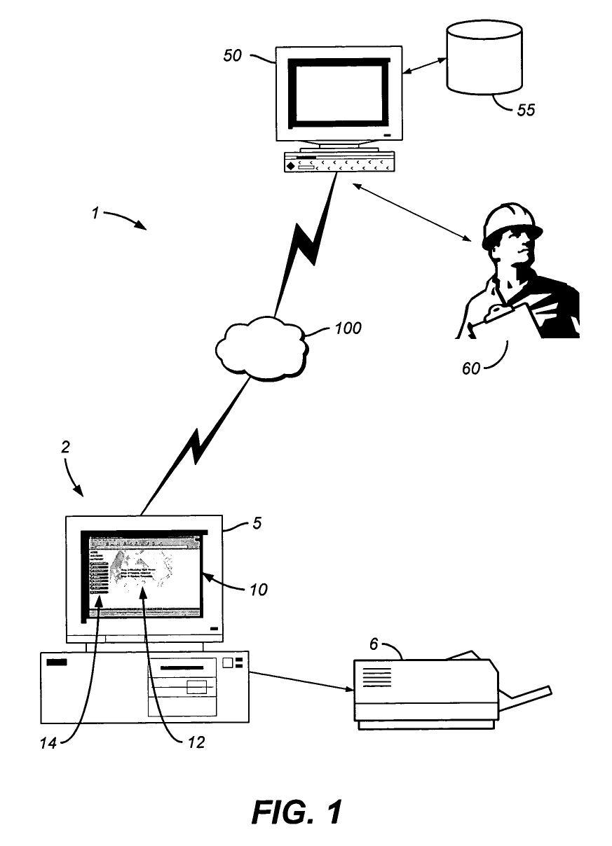

Referring now to FIG. 1, in an exemplary embodiment system 1 comprises server 50 which may be accessible to another computer such as computer 2 via data network 100. For simplicity, as used herein “user 2” is a customer or client who has access to computer 2. User interface 10 is displayable on display 5 and comprises first region 12 and second region 14. First region 12 and second region 14 may be fixed in location on display 5 or may vary. All or a portion of user interface 10 may be available via one or more display formats available via data network 100 such as a hypertext markup language page available from server 50 over the Internet or further via electronic mail, facsimile, or toll free number, or a combination thereof. Server 50 may have access to one or more service providers 60, e.g. through the Internet.

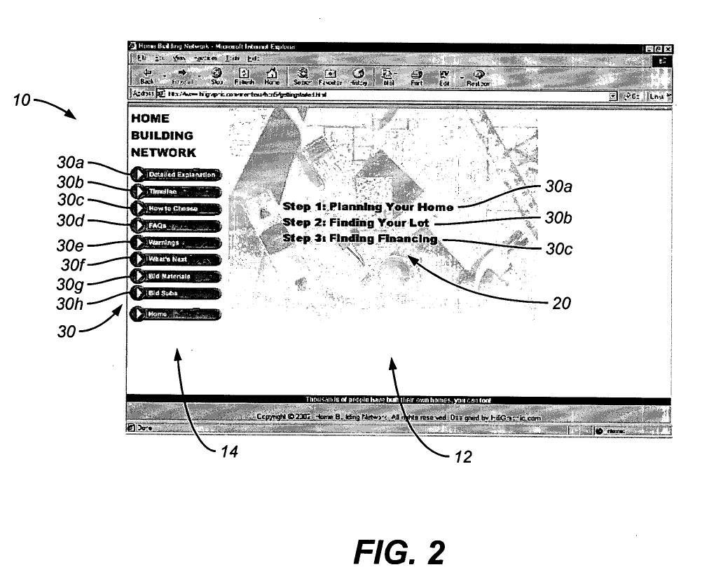

Referring now to FIG. 2, first region 12 further comprises a first user interface element, generally referred to herein using the numeral “20” and more specifically shown in FIG. 2 as first user interface elements 20a, 20b, and 20c. First user interface element 20 is useful for setting a construction service context and may comprise one or more graphical components 24 (not shown in the figures) which may be visually related to the construction service context. As used herein, graphical components 24 may comprise text, photographically derived images such as from video or other photographic images, graphics such as icons or bitmaps, or the like, or a combination thereof. Additionally, graphical components 24 may be presented to user 2 (FIG. 1) on user interface 10 in an outline format where at least one first user interface element 20 exists for each of a predetermined set of stages of construction.

Second region 14 further comprises a second user selectable user interface element, generally referred to herein by the numeral “30” and more specifically shown in FIG. 2 as elements 30a through 30h. Second user selectable user interface element 30 is useful for providing additional information related to one or more project steps, e.g. steps to complete a stage in a construction context defined by a selection of user interface element 20 in first region 12 such as by user 2 (FIG. 1). For example, selection of user interface element 20 in first region 12 may set a construction context to be a project for a new residence, and a planning stage for that construction context may include steps comprising choosing a lot, choosing a realtor, choosing a construction lawyer, setting a budget, finding financing, choosing an architect/designer, developing plans, choosing upgrades, choosing a contractor, or asking questions such questions related to that stage, e.g. using user interface 10, electronic mail, facsimile, toll free number, in person or the like, or a combination thereof.

Each second user selectable user interface element 30 may comprise a plurality of user selectable user interface elements, e.g. 30a through 30h, where user selectable user interface elements 30 may comprise detailed information related to a project step. For example, in an exemplary embodiment, user selectable user interface element 30 may comprise a detailed information element 30a; a timeline project scheduling element 30b; a “how to choose” element 30c; an FAQ element 30d; a warnings and checklists element 30e, which may further comprise information regarding conditions or facts about which a user should be aware, e.g. common mistakes or omissions, or a checklist which helps define what constitutes a correctly completed step; a “what's next” element 30f; a bid materials element 30g; and a bid services element 30h. Responses, e.g. to FAQ inquiries, may be available via user interface 10, electronic mail, facsimile, toll free number, in person, or a combination thereof

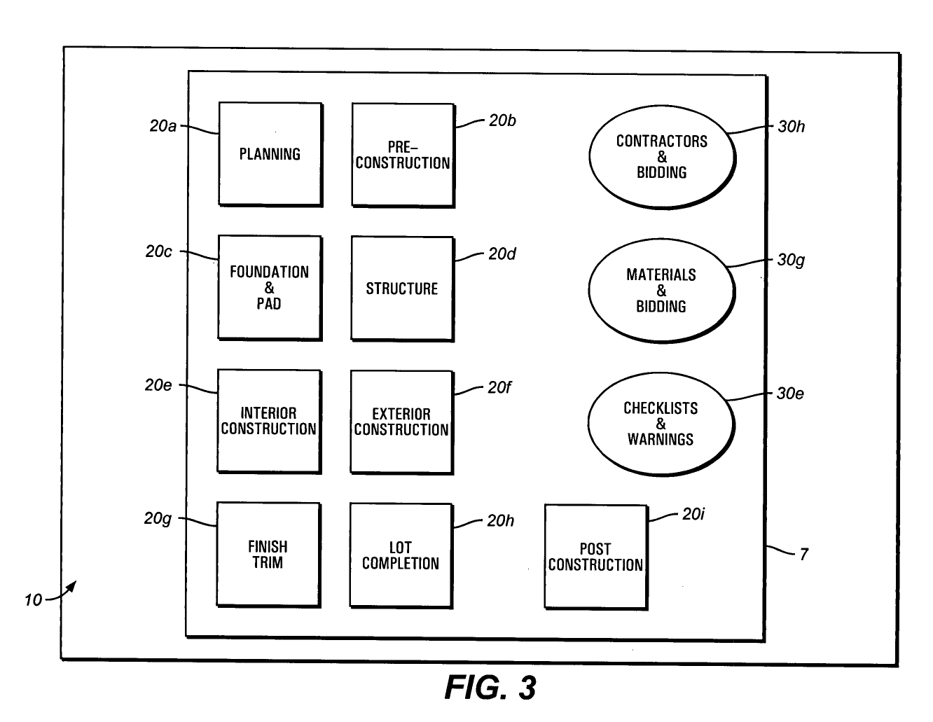

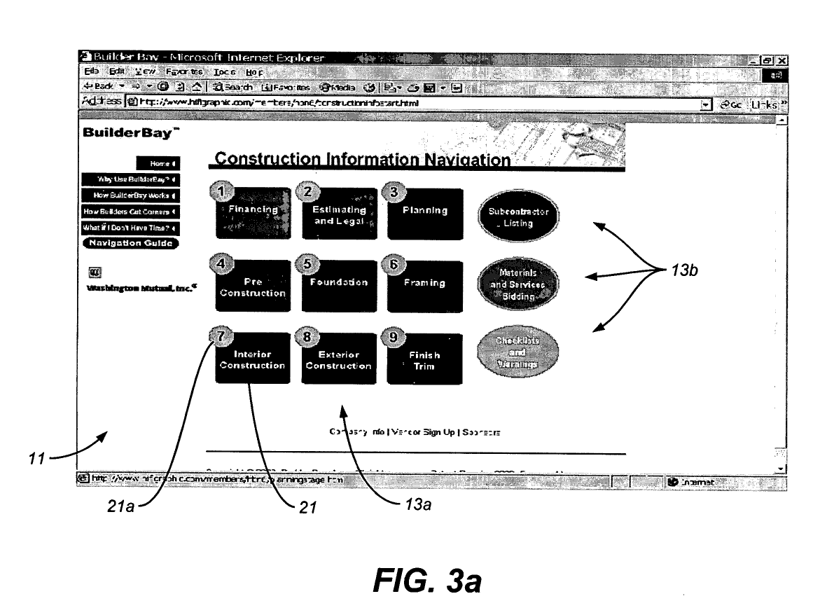

In an exemplary embodiment, a detailed description of a construction stage or step associated with user selectable user interface element 30 may further reflect one or more alternatives, e.g. an analysis of relative cost versus quality or other factors such as durability or longevity of elements present in a construction service context step or stage. For example, referring now to FIG. 3, navigation display 7 may be displayed on display 5 (FIG. 1) to allow a user to choose between one or more stages of construction such as by using first user interface element 20 and/or second user interface element 30 which represent a predetermined one of the stages of construction. These stages of construction may include a planning stage, a pre-construction stage, a foundation stage, a structure construction stage, an interior construction stage, an exterior construction stage, a finish construction stage, a lot completion stage, a post construction stage or the like, or a combination thereof. Additionally, display 5 may further contain additional user selectable user interface elements such as 30e, 30g, and 30h which may allow access to a geographic contractors and service providers function, a materials providers function, a checklists function, a warnings function, and the like.

In an exemplary embodiment, user selectable user interface elements 20,30 may be useful to provide a predetermined response related to the construction service context upon selection of that user selectable user interface element 20,30. For example, selection of a user selectable user interface element 20,30 for a stage may lead to further information about each step of that stage, e.g. detailed information comprising or related to that stage. Access to the further, construction context sensitive information may be accomplished by user selectable user interface elements 20,30 or all or a portion of such further, construction context sensitive information may be additionally available via electronic mail, facsimile, toll free number, in person, or a combination thereof.

In a preferred embodiment, each user selectable user interface element 20,30 will be associated with one or more functions that provide detailed information about a step associated with the user selectable user interface element 20,30. For example, the detailed information may comprise information as to where the desired construction step falls in a project timeline; a “How to Choose” function related to selection of material and/or contractors for the step; warnings and checklists related to the step; frequently asked questions about the step; a question submission function that allows submission via user interface 10, facsimile, electronic mail, toll free number, in person, or a combination thereof; a directory of contractors from which to solicit bids related to the step; a directory of construction suppliers or materials manufacturers to solicit bids for materials; a discussion of a “What's Next” step in the project timeline; a section where regional experts provide their advice; a discussion of legal issues or documents; and the like. In an exemplary embodiment, responses to inquiries and requests for information and/or advice may be provided via user interface 10, electronic mail, facsimile, toll free number, in person or a combination thereof.

Referring back to FIG. 2, user interface 10 may also be used to display a directory of construction service providers (not shown in the figures), e.g. a directory listing contractors, materials suppliers, materials manufacturers, and the like. Construction service providers may include financial service providers, legal services providers, insurance service providers, construction materials providers, construction labor providers, architectural service or home design service providers, engineering service providers, surveying providers, inspection providers, real estate brokerage providers, interior designers, exterior designers, landscape designers, pool designers, lighting designers or the like. As used herein, an interior designer, an exterior designer, and/or a landscape designer may offer services related to furniture, a home theatre, a pool, fencing, landscaping, flooring, decking, window or wall covering, and the like, or combinations thereof.

By way of additional example, the explanation of a stage involving a foundation such as may be associated with detailed information element 30a may include a discussion of the different types of foundations; how each is constructed; a discussion of the relative costs and benefits of each type of foundation; a recommendation from regional experts on which types are recommended for each region; or a combination thereof.

Timeline project scheduling element 30b may comprise detail regarding a project timeline or project plan, e.g. where each step fits into an overall construction timeline; when the step should be scheduled; an estimate of how long each step should take; and a comparison of how much the step costs versus a budget. For example, the foundation work may come after the planning, financing, estimating, land acquisition, and other pre-construction stages. An exemplar of a project plan is illustrated in FIG. 7.

How-to-choose user interface element 30c may be used by a users to access information about specific needs, and may be limited to a specific region, and may include recommendations from regional experts. For example, how-to-choose user interface element 30c may be used to provide information on choosing a contractor for a remodeling project. How to choose user interface element 30c may also be used to provide information on how to choose between materials options and construction alternatives, e.g. by geographic region, as well as the relative cost and quality of a material option and alternative from a regional expert.

FAQ user interface element 30d may be used to provide information in the form of a question and answer format (FAQ) about a predetermined stage. An FAQ may be tutorial in nature, e.g. combine a stylized question and its answer. For example, an FAQ may pose a question on whether or not a professional surveyor should be used, and the answer to the FAQ may explain when, where, and why a professional surveyor should or should not be used. The FAQs could also be posed by and answered by a regional expert.

Warnings and checklists user interface element 30e may comprise information regarding areas in which contractors may cut corners and do a poor job; areas of common mistakes; areas where contractors may omit steps or materials; areas where special attention needs to be taken; regional problems and issues discussed by regional experts or the like; or combinations thereof. Checklists related to determinants of an acceptable level or performance for a predetermined stage may be provided, e.g. a list of recommended materials to use and relative costs, a list of the most frequent mistakes/problems encountered during construction, a list of common omissions, or the like, or a combination thereof.

“What's next” user interface element 30f may comprise a reminder about steps, e.g. comprising contractors and/or materials, which need to be scheduled for an upcoming stage or scheduled concurrently with a construction stage to keep the project on time.

Bid materials user interface element 30g may be used to provide a user with information related to materials suppliers in a predetermined stage as well as provide a standard bid request form for the details of a bid request. Additionally, bid materials user interface element 30g may provide a solicit bids function to allow solicitation from regional and/or national materials suppliers or manufacturers by either electronic mail, facsimile, toll free number, in person, or regular mail.

Bid services user interface element 30h may be used to provide a directory of service providers needed at a predetermined stage. The directory of providers of construction services 60 is typically construction service context sensitive, e.g. it may change depending on the construction context currently selected, including filtering the directory based on a geographical location of the user and/or the construction project. The construction service context sensitive directory of providers of construction services 60 may comprise a construction service context sensitive directory of providers of construction services 60, a construction service context sensitive directory of providers or manufacturers of construction materials, a construction service context sensitive bidding request form, or a construction service context sensitive bidding display, or the like, or a combination thereof.

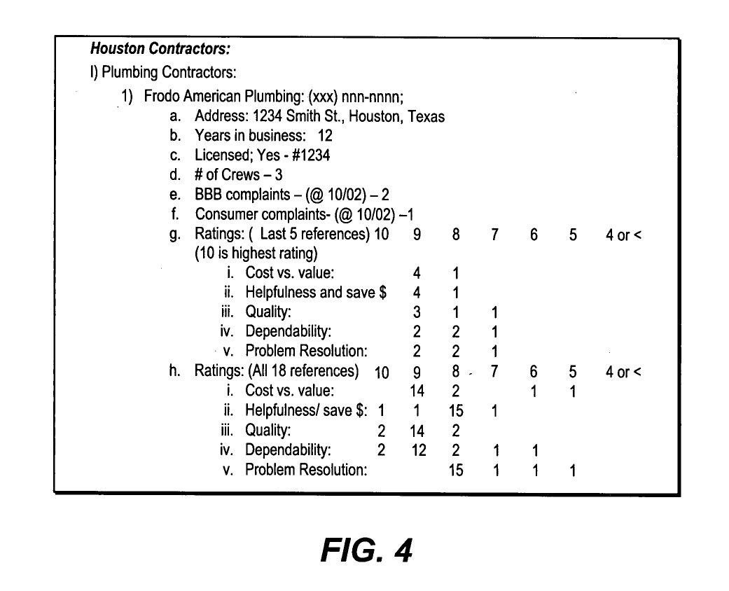

Additionally, the directory, i.e. of the providers of construction services 60 and/or of construction materials, may further comprise information about and a customer rating for a predetermined set of the providers, such as a set of providers of construction services 60 and/or construction material in a geographic region. Ratings may comprise indicia of cost versus value, quality of workmanship, responsiveness, dependability, clean up, problem solving or the like filled out by references or clients that have used the provider's services. The indicia may further be scaled such as on a 1 to 10 scale. For example, when a provider or contractor is initially admitted into the directory, the provider or contractor may be asked to provide one or more references. These references may be contacted and asked to rate the provider or contractor according to one or more predetermined indicia. These responses may be used to create an initial rating for that provider or contractor, an exemplar of which is shown in FIG. 4. As users of user interface 10 or system 1 (FIG. 1) employ these providers or contractors, ratings solicited from the users may be added to and incorporated in the provider or contractor indicia.

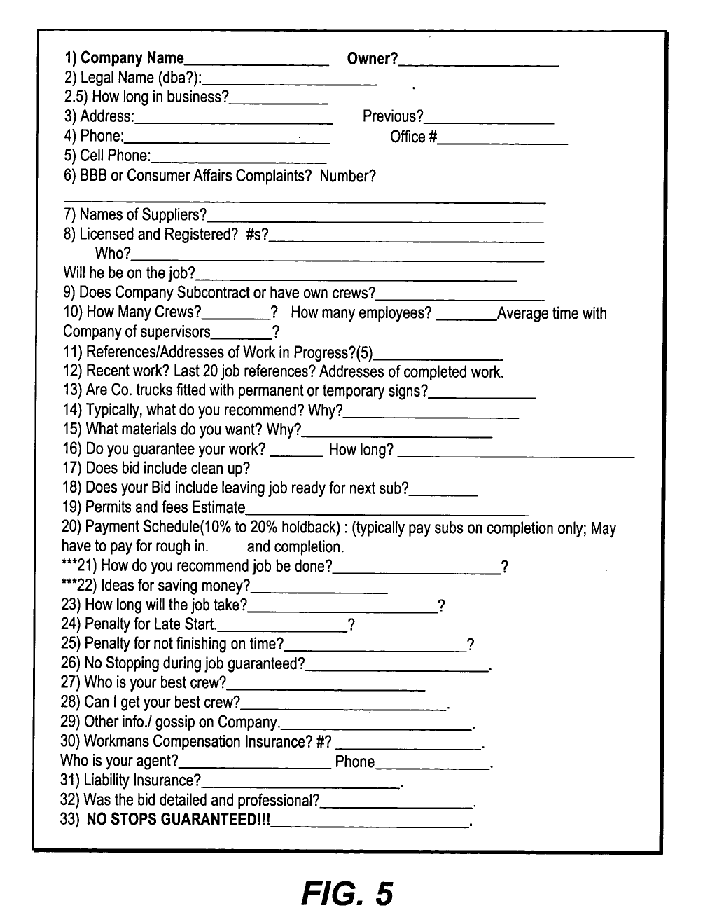

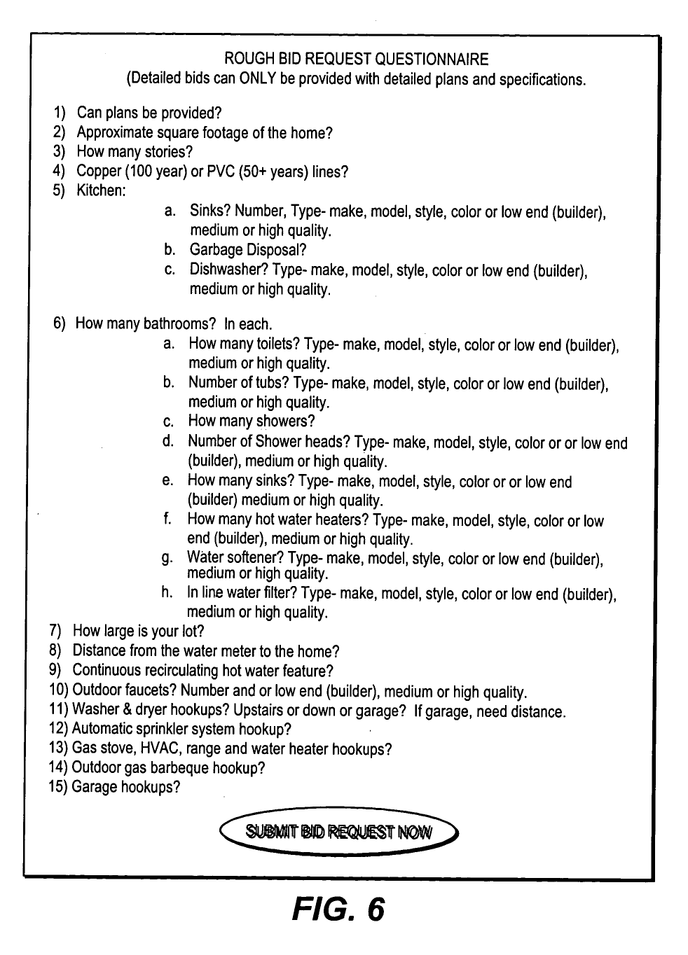

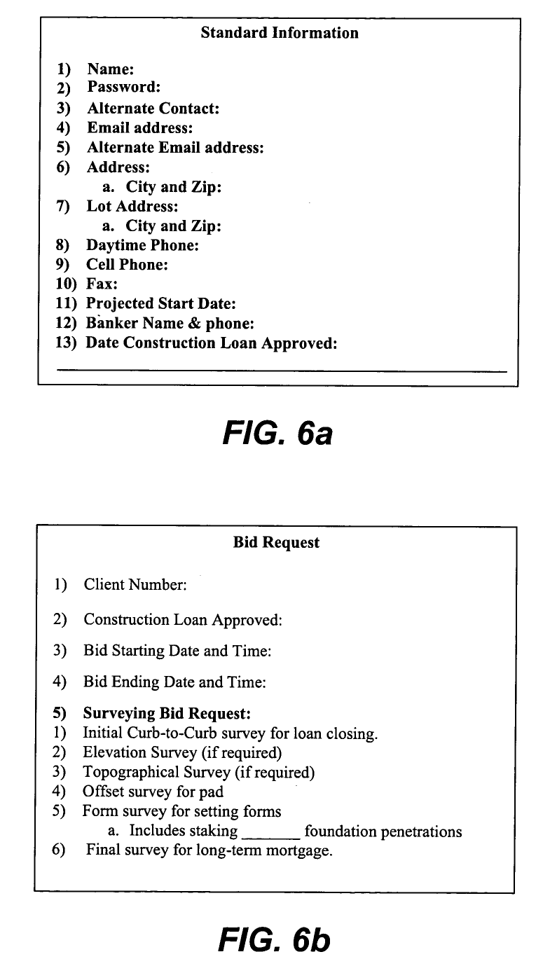

Access to one or more bidding services, such as via the directory, may allow the user, who may be a potential consumer of construction services, to provide one or more construction service providers with a request for a bid or additional information on a construction service related to the desired construction service context. Such construction service providers may be required, in order to participate in system 1 and be listed on the directory, to provide information, an exemplar of which is illustrated in FIG. 5. Additionally, a construction service provider 60 who desires to bid on the requested services may, in turn, provide the consumer with a bid for such services. The bid may be provided by e-mail or stored, such as on persistent data store 55 (FIG. 1) accessible to server 50 (FIG. 1) for later retrieval and review by the user, such as using user interface 10 or via electronic mail, facsimile, regular mail, or dropped off in person. An exemplar of a bid request form is illustrated in FIG. 6.

Referring now to FIG. 7, a construction project plan timeline may be created using user interface 10 (FIG. 1). User interface 10 may be used to provide a potential consumer of construction services with access to resources required to accomplish the desired construction. User interface 10 may be available online such as through the Internet and the project plan created with user interface 10 may be tailored to a specific geographic region. In addition to providing information sufficient to create a project plan, system 1 (FIG. 1), using user interface 10, may further provide information on how to accomplish the project plan to initiate and complete the project as well as a directory of construction service providers and construction materials providers and a method to solicit bids or information from these providers, e.g. using user interface 10, electronic mail, facsimile, toll free number, or in person, or a combination thereof.

FIG. 3a illustrates an alternative user interface which comprises construction navigation page 11 (FIG. 3a) and construction bid pages (generally FIGS. 6, 6a, and 6b).

Construction navigation page 11 further comprises user selectable region 13a to provide user 2 (FIG. 1) with access to a predetermined plurality of stages of construction, as well as user selectable region 13b to supply user 2 (FIG. 1) with access to information related to construction service provider 60 (FIG. 1) (e.g., a subcontractor or a materials vendor), a checklist, a warning, a “what is next” informational section on the construction timeline, or the like, or a combination thereof. In an exemplary embodiment, button 21a or another user selectable region of construction navigation page 11, e.g. a portion of display 5 (FIG. 1) associated with each of the stages of construction as illustrated in FIG. 3a, may be selected by user 2 to invoke a bid request, e.g. a “request for bid” (RFB) or a “request for proposal” (RFP).

One or more construction bid pages, e.g. FIGS. 6a and 6b, may exist and may further comprise a user selectable region to allow user 2 (FIG. 1) to enter data related to a desired construction product or service. A construction bid page may further comprise a user selectable submit bid region to allow user 2 to access remote service 50 (FIG. 1) and provide remote service 50 with data related to the desired construction service. Information and data submitted by user 2 (FIG. 1) may then be further provided to construction service providers 60 (FIG. 1) such as by e-mailing construction service providers 60 with data provided in free form text or formatted text, e.g. HTML. In currently envisioned alternative embodiments, data may be provided in an otherwise interrogatable format. By way of example and not limitation, user 2 may be provided a specific forms, e.g. for a door with boxes to click for door heights, door widths, door construction or door styles. The specific form may then be e-mailed to construction service providers 60.

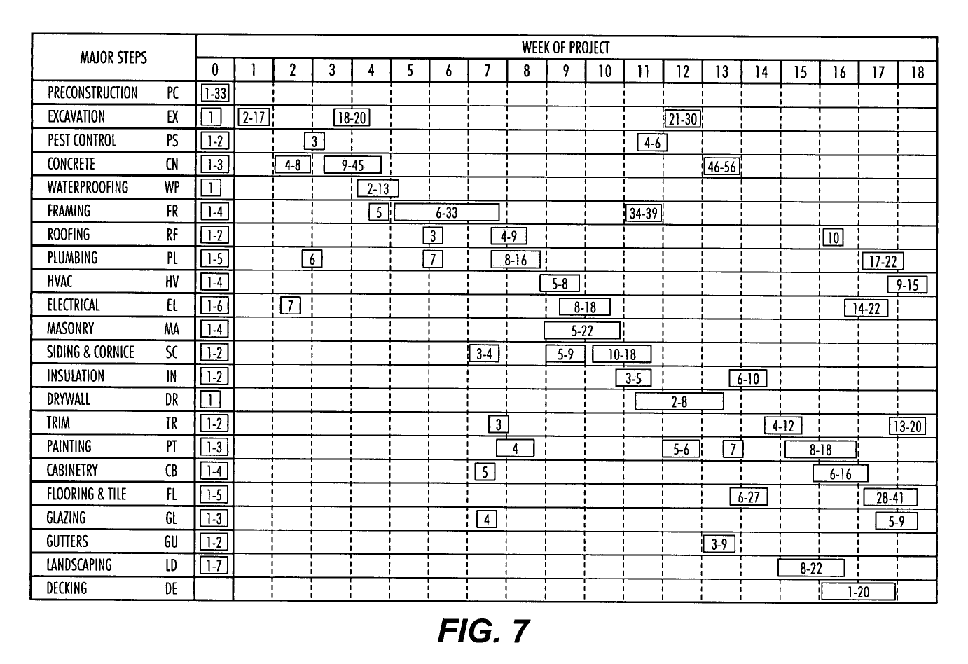

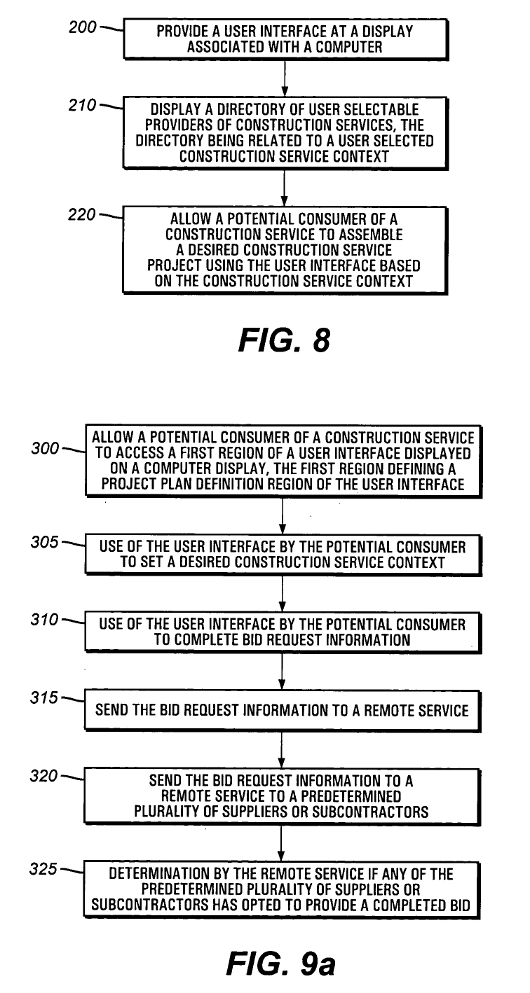

In the operation of an exemplary embodiment, referring now to FIG. 8, a user, e.g. at computer 2 (FIG. 1) who may be a potential consumer of construction service, is provided with user interface 10 (FIG. 1) at display 5 (FIG. 1) associated with computer 2 (FIG. 1), step 200. As used herein, “computer 2” refers to a computer accessed by a user who, when accessing the computer, is referred to herein as “user 2.” A predetermined initial display may be presented to user 2. For example, the initial display may comprises a promotional message, a user selectable region to indicate acquiescence by the user to services provided by the site, or the like, or a combination thereof.

User 2 is allowed to assemble a desired construction service project, e.g. create a project plan (an exemplar of which is shown in FIG. 7) including a project timeline, using user interface 10 based on a construction service context selected by User 2, or to estimate the cost of the project according to the project plan, or a combination thereof.

In an exemplary embodiment, user 2 (FIG. 1) who is a potential consumer of construction services may be allowed to access a first region of the user interface which defines a project plan definition region of user interface 10 (FIG. 1) displayed at a computer 2 (FIG. 1), e.g. first region 12 (FIG. 1). As used herein, “potential consumer” is equivalent to “user 2.”

Using user interface 10 (FIG. 1), user 2 (FIG. 1) may define a project plan, which may further comprise a timeline, for a desired construction service where the project plan may be associated with a desired construction service context.

User 2 (FIG. 1) may be allowed to access a set of resources related to the project plan, e.g. financing, insurance, labor, material, and/or professional services. Additionally, resources may further comprise general and regional advice and information, services or products or the like, or combinations thereof.

Using a user selectable user interface element 20,30 (FIG. 1) on user interface 10 (FIG. 1), user 2 (FIG. 1) may further access one or more providers 60 (FIG. 1) of one or more construction services, step 210. In a currently preferred embodiment, user interface 10 further provides a customer rating of the provider of the construction service, such as using a directory of such providers 60.

Additionally, user 2 (FIG. 1) may be allowed to provide one or more construction service providers 60 (FIG. 1) with a request for a bid on services related to the desired construction service context, step 220. Construction service providers 60 who desire to bid on the requested services may then provide user 2 with a bid such as by using electronic mail or an electronic reply accessible from user interface 10 (FIG. 1), facsimile, toll free number, in person, regular mail of construction plans or specifications, or combinations thereof.

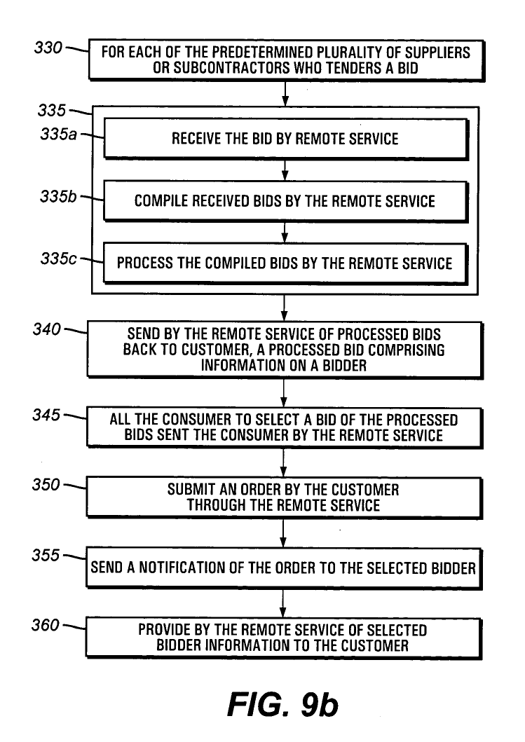

Alternatively user 2 (FIG. 1) may be allowed to use a user interface, e.g. 11 in FIG. 3a, to complete bid request information, e.g. step 310 in FIG. 9a. As used herein, “bid request information” comprises data necessary to delineate construction related planning and costing including, but not limited to, an electronically transmittable construction plan.

In keeping with the description of exemplary embodiments described herein above, a project plan may be converted into an electronically manipulatable form of the desired construction service project, an electronic form of the desired construction service project viewable at a computer, a paper form of the desired construction service project, or the like, or a combination thereof.

When sufficient detail is present for a project plan of user 2 (FIG. 1), an estimate of the cost of the project plan may be generated such as by use of an estimating program geared to the region in which the construction will be located. This estimate may then be verified by bids submitted by construction service providers 60 (FIG. 1), e.g. contractors and the materials providers in the region.

Thus, system 1 (FIG. 1), using user interface 10 (FIG. 1), may allow user 2 (FIG. 1) to define and obtain details from national or regional experts on not only what to do, but how to do what is needed, as well as access to the means to plan and execute their plan.

User 2 (FIG. 1) may access user interface 10 (FIG. 1) through computer 2 (FIG. 1) operatively in communication with data packet network 100 (FIG. 1) such as the Internet. Using user interface 10, user 2 may be provided with a project plan (FIG. 7) for construction service context desired by user 2, e.g. a home construction or remodeling project. The project plan may comprise a chronologically arranged set of instructions, information, guidelines, materials, providers, and costs (e.g., estimated versus actual) useful to accomplish the desired construction service context. In a currently envisioned embodiment, access may be provided to the user interface for a fee, although access may be totally free or partially free. Providers 60, e.g. contractors, may also pay a fee to be listed in a directory of such providers 60.

By way of further example, user 2 (FIG. 1) may have selected a first user interface element 20 (FIG. 2) which sets the construction service context to an improvement to or remodeling of a residence, e.g. element 20c. User 2 may further desire to investigate finding financing. Accordingly, selectable user interface element 30d (FIG. 2), FAQ, may, when selected by user 2, present user 2 with a predetermined set of frequently asked questions related to alternatives for financing and home improvement loans, home equity loans, and the like, or combinations thereof. For example, FAQ may include questions such as “Where do I get the down payment?,” “What do I do if I have bad credit?,” “What information do I have to give the mortgage company or bank?,” “If I have some money saved, should I spend it on the construction first and then go see the bank?,” “What is a ‘one time close’ mortgage loan?,” “How long should I take a mortgage out for: 15 years, 20 years, 30 years?,” along with answers to the FAQ.

Depending on the construction service context, advice from national or regional experts provided user 2 (FIG. 1) may comprise how to choose material for the desired construction service context; how to choose a contractor for the desired construction service context, the various construction options for each service context and what they cost relative to each other option, as well as advice about which construction options are recommended for each geographic region; general information related to the desired construction service context, warnings and checklists of desirable elements relevant to the desired construction service context, further steps in a timeline for a project related to the desired construction service context, or the like. Advice may further comprise display of a graphic on display 5 (FIG. 1) such as an illustration or a photographically derived demonstration such as a video demonstration or one or more photographic images, where the graphic is related to the desired construction service context, e.g. a representation of a step accomplished correctly and a representation of a step accomplished poorly.

As different geographical regions may have different building issues and/or differing requirements for dealing with building issues, advice may be augmented, developed, and/or presented to user 2 (FIG. 1) on a geographical basis, e.g. from an expert or other entity such as an inspector familiar with that geographic region. Accordingly, in an exemplary embodiment, advice additionally may be related to a specific geographic region, e.g. tailored or otherwise restricted to that specific geographic region. One or more “how to” user selectable interface elements 20,30 (FIG. 2) may reflect the geographic region for the desired construction context. In an alternative embodiment, a separate user selectable interface element 20,30 may be present to provide access to regional advice and/or regionally tailored warnings and checklist functionality.

In an exemplary embodiment, a project plan (FIG. 7) may comprise a chronologically sequenced set of information regarding the desired construction service project, i.e. stages. The set of information may further comprise step by step examples to be used such as for guidance in pursuing the construction plan, i.e. steps of each stage. In an exemplary embodiment, the step by step examples may further be segmented such as by stage of construction. For example, in a currently envisioned exemplary embodiment, segments may include a stage which occurs while planning to remodel or build, a pre-construction stage which occurs before user 2 (FIG. 1) engages in the construction services, a stage for foundation construction, a stage for structure construction, a stage for interior construction, a stage for exterior construction, a stage for a finishing construction, a stage for lot completion, and a stage for furnishing and/or upgrading the home.

Each stage may further set and/or further define a construction service context which is further detailed by the steps for that stage. For example, a stage for planning may include steps addressing mortgages, choosing and purchasing real estate, choosing a realtor, choosing an attorney, choosing an exterior facade, developing a construction plan, choosing an architect or designer, choosing upgrades for the project, estimating costs, choosing contractors, obtaining surveys and engineering drawings, obtaining additional information, and obtaining permits and approvals. These steps may occur before user 2 (FIG. 1) engages in the construction services and may set a construction context which further comprises information on alternatives, advice, guidelines, warnings, checklists, what steps to schedule either concurrently or next and/or frequently asked questions (FAQ) related to background information.

A pre-construction or structure construction stage may set a construction context which further comprises one or more steps to complete each stage. Each step may further comprise advice, both general and regional, or information, guidelines, warnings, checklists, “what's next,” FAQ, as well as a directory of contractors and materials available for bid related to each step of the stage. For example, a pre-construction stage may comprise steps including permits and approvals; elevation surveys; clearing the lot, e.g. of brush or other vegetation or other obstructions; obtaining temporary electricity, dumpster, and porta-potty services; site excavation and preparation; construction surveys; creation of foundation forms, drilling, and pouring footings or piers; sub-rough plumbing, sub-rough electrical and heating, and air conditioning services (HVAC); moisture barriers; termite spraying; foundation drainage, backfill, and rough grade; basement rough-in; and inspections.

A structure construction stage may set a construction context in which information, how to choose materials and/or service providers, advice, guidelines, checklists, warnings, FAQ or requests for additional information are related to each step of this stage, e.g. framing, sheathing and waterproofing such as housewrap, roofing and soffets, ridge vents, windows and exterior doors, rough plumbing, rough electrical, HVAC and gas lines, and inspections.

An interior construction stage may set a constriction context in which information, how to choose materials and/or service providers, advice, guidelines, checklists, warnings, FAQ, and/or requests for additional information are related to each step of this stage, e.g. wall insulation, drywall, finish carpentry, interior painting, floors, moldings, and inspections.

An exterior construction stage may set a constriction context in which information, how to choose materials and/or service providers, advice, guidelines, checklists, warnings, FAQ, and/or requests for additional information are related to each step of this stage, e.g. fascia work such as brick, siding, or stucco, completing porches, and inspections.

A lot completion stage may set a constriction context in which information, how to choose materials and/or service providers, advice, guidelines, checklists, warnings, FAQ, and/or requests for additional information are related to each step of this stage, e.g. final grading, sidewalks and driveway, electric and gas laterals tie ins, sodding, foundation plastering, and inspections.

A finish construction stage may set a constriction context in which information, how to choose materials and/or service providers, advice, guidelines, checklists, warnings, FAQ, and/or requests for additional information are related to each step of this stage, e.g. cabinets and counters, showers, tubs and tile, finish plumbing fixtures, finish electrical fixtures, finish HVAC, finish painting, and exterior painting, flooring, tiling and carpet, hardware, landscaping, final inspection, and miscellany such as punch lists and inspections.

With each stage, certain definitions used in the construction context may be eliminated or expanded, such as depending on geographic or other factors. For example, basements are relatively unknown and unused in certain portions of the United States and may be excluded if user 2 (FIG. 1) or project is located in such a portion of the United States. Further, as each construction context is set, user selectable elements 20,30 (FIG. 2) may further comprise user selectable video or other graphic presentations which are related to the construction context and which provide additional information such as a “how to” tutorial for an item relevant to the construction context.

Once assembled, the construction service project may be converted into an electronically manipulatable form of the desired construction service project, an electronic form of the desired construction service project viewable at a computer, a paper form of the desired construction service project, or the like, or a combination thereof. For example, a project plan (FIG. 7) may be created and sent via electronic means to user 2 (FIG. 1) such as with e-mail or printed such as on printer 6 (FIG. 1).

In an exemplary embodiment, user 2 (FIG. 1) may further be provided with a user selectable directory of construction service providers 60 (FIG. 1) at any point during use of user interface 10 (FIG. 1) or user interface 11 (FIG. 3a). The user selectable directory may comprise a user selectable user interface element 20,30 (FIG. 2) which, when selected, provides access to a desired construction service provider 60 in a particular geographic region available from the directory, information and customer ratings for a predetermined set of construction service providers 60 in a currently displayed directory of construction service providers 60, information and consumer ratings for materials associated with a predetermined set of construction service providers 60 in the currently displayed directory of construction service providers 60, or the like, or a combination thereof.

Content of the user selectable directory may be limited to a geographic area such as may specified by a geographic limit option, e.g. by use of a user login. Additionally, content of the user selectable directory may be limited to construction service providers 60 (FIG. 1) associated with the desired construction service context, limited to construction service providers 60 associated with a currently selected user interface element, or the like. For example, a user login associated with user 2 (FIG. 1) located in Houston, Texas may restrict user 2 access to content of the user selectable directory limited to a predetermined geographic area around Houston, Tex.

User 2 (FIG. 1) may wish further information regarding building material available from one or more construction service providers 60 (FIG. 1) or may wish to solicit one or more bids for one or more construction services, e.g. labor. If user 2 so desires, user 2 may further access information or other features of the construction service provider 60 such as by online access to additional information about the desired construction service provider 60 or online access to bid solicitor for the desired construction service provider 60. The additional information may comprise a name, an address, contact information, and the like and may be obtained using user interface 10, electronic mail, facsimile, toll free number, in person or a combination thereof.

In an embodiment, user 2 (FIG. 1) may be provided with access to a bulk provider or a manufacturer of material related to the desired construction service context. In such an embodiment, user 2 may further be provided with shipment of material from the bulk provider of materials such as by using a break bulk distributor. In this manner, cost of the material may be lessened for user 2.

Referring now to FIGS. 9a and 9b, in a further exemplary method, user 2 (FIG. 1) may use user interface 11 (FIG. 3a) to define a timeline, procedure and execution means for a project, the project comprising a desired construction service, where the project associatable with the desired construction service context. As used herein, “construction service” comprises at least one construction related product, service, or material, by way of example and not limitation including Construction Financing; Mortgage Financing; construction, property, or life insurance; title insurance; surveying; appraisals; construction materials; construction professionals; window products including window accessories; door products including door accessories; electrical products and/or fixtures; plumbing products, accessories including fixtures; appliances; flooring products including floor accessories; wallcovering products including accessories; window covering products including accessories; pool products including accessories; fountain products including accessories; spa products including accessories; decks, roofing products; air conditioning and heating products; insulation products; landscaping products including accessories; or the like; or combinations thereof.

Data from the timeline, advice, procedures, and architectural plans and architectural advice may be used, e.g. by a process executing either locally at computer 2 (FIG. 1) or at remote service 50 (FIG. 1) to complete a bid request form with bid request information.

In an embodiment, preliminary payment is obtaining from user 2 (FIG. 1) before offering services. The preliminary payment may be obtained via an electronic form of payment, e.g. credit card over the Internet, or a non-electronic form of payment, e.g. payment by check through the mail. A predetermined amount of information may be provided to user 2 without first having obtained the preliminary payment. The preliminary payment may comprise a payment for information or a payment to allow access to information concerning one or more suppliers of construction services for a predetermined area or the like. For example, the predetermined area may be related to the submitted bid and the information may comprise a name of a supplier of construction services, a business address of the supplier of construction services, company background of the supplier of construction services, client feedback related to the supplier of construction services, feedback from other sources related to the supplier of construction services, a commercial business information bureau such as a BETTER BUSINESS BUREAU, a consumer service, a supplier information, or the like, or a combination thereof.

Upon receipt of the preliminary payment, user 2 (FIG. 1) may be provided with a unique project number, a password selection form to either provide a password to user 2 or solicit a password from user 2, a personal information submission form, or the like, or a combination thereof. In an embodiment, user 2 may be required to accept predetermined terms before proceeding, e.g. an agreement to not disclose information regarding a subcontractor or information regarding materials vendors to anyone else, notice of damages if user 2 discloses any such information, a release of liability, an agreement by user 2 that user 2 shall follow recommended procedures and suggestions, an agreement that user 2 should seek local legal representation to review all legal forms, or the like, or a combination thereof. Recommended procedures and suggestions may include advising user 2 to never provide payments up front prior to when services are rendered, to seek multiple bids, to check multiple references, and to ensure that all legal paperwork is filled out and signed prior to allowing subcontractors to begin work or prior to paying any subcontractors. User 2 may further be required to agree that if user 2 does not follow all procedures and recommendations and sign all paperwork, user 2 agrees to hold remote service 50 harmless.

In an embodiment, user 2 (FIG. 1) may be required to use the project number and the password each time user 2 visits remote service 50 (FIG. 1), e.g. accesses remote service 50, to access functionality available through the remove service. Remote service 50 may restrict access at remote service 50 based on the submitted bid. User 2 who is logged on may be provided with an estimator useful to estimate costs of construction, e.g. the estimator may be capable of being configured to estimate the costs by a geographical region or provide a high, medium and low cost estimate.

Logged in user 2 (FIG. 1) may be provided with form, e.g. on display 5 (FIG. 1), useful to supply a predetermined specification for a commodity associated with the submitted bid, supply predetermined construction detail specification associated with the submitted bid, and submit the predetermined specification to remote service 50 (FIG. 1). As used herein, “logged in user 2” may be logged in user 2 or an authorized, logged in designate of user 2.

A standard bidding request may be used and filled out, and plans provided, by user 2 (FIG. 1), an authorized designate of user 2, or a combination thereof to complete the bid request form, step 310. A bidding process may comprise an unlimited number of rounds of bidding or be limited to a predetermined number of rounds of bidding on one set of floor plans for a predetermined group of building materials. The group of building materials may include lumber and building products such as plywood, oriented strand board, drywall, trim or cabinet wood, cabinets, and/or molding; windows; plumbing materials; plumbing fixtures; electrical materials; electrical fixtures; doors; hardware; roofing materials; insulation materials; flooring; wall covering; cabinet counter tops; pools; spas; fountains; landscaping; decks; or the like; or a combination thereof.

Bid request information is sent to a remote service, e.g. one executing at server 50 (FIG. 1), as opposed to being sent directly one or more bidders, step 315. Once received at remote service 50, remote service 50 may send bid request information, e.g. an RFB, to a predetermined plurality of suppliers or subcontractors 60 (FIG. 1) for bid, step 320.

Once bid request information has been sent, step 320, to the predetermined plurality of suppliers or subcontractors 60 (FIG. 1), remote service 50 (FIG. 1) may determine, step 325, if any of the predetermined plurality of suppliers or subcontractors has opted to provide a completed bid, e.g. upon receipt of an electronic message back from that supplier or subcontractor 60 (FIG. 1).

For each of the predetermined plurality of suppliers or subcontractors 60 (FIG. 1) who tenders a bid, remote service 50 (FIG. 1) receives the bid (step 335a), compiles received bids (step 335b), processes the compiled bids (step 335c), and sends the processed bid, step 340, back to user 2 (FIG. 1). In a preferred embodiment, each received bid may be marked up by remote service 50 by a predetermined amount. Remote service 50 may retain the marked up amount upon selection of a bid by user 2. Additionally, remote service 50 may provide a payment method that allows both the service or material provider 60 and remote service 50 to track purchases of user 2 whereby the service providers and materials providers 60 pay remote service 50 a commission for any products or services sold, e.g. by the service providers and materials providers to user 2. In an embodiment, electronic orders and payments may be tracked by remote service 50 to provide for payment of commission to or by tracked vendors and suppliers.

In a preferred embodiment, a processed bid comprises information on a bidder but processed bids are sent without the names of the parties bidding back to user 2 (FIG. 1). Information on a bidder may comprise a number of years that bidder has been in business, a number of employees available to that bidder, a number of crews available from that bidder, reference information for that bidder, answers to a predetermined Contractor's Questionnaire, prior customer feedback information on that bidder, or the like, or a combination thereof. As used herein, “prior customer feedback information” may include descriptions of the quality of the products or services provided, the punctuality of the vendors or service provider's employees, the professionalism of the vendors or service provider's employees, or user 2 rating of the value of the products or services provided, or the like, or a combination thereof

User 2 (FIG. 1) may be allowed, step 345, to select a bid of the processed bids sent user 2 by remote service 50 (FIG. 1). If user 2 selects a bid, user 2 notifies remote service 50 of the selected bid, e.g. user 2 submits an order through remote service 50, and remote service 50 sends of a notification of the order to the selected bidder 60 (FIG. 1). Orders may be submitted using a credit card or a check, either online such as using display 5 (FIG. 1) via the Internet 100 (FIG. 1) or by mail. Upon such notification, remote service 50 provides selected bidder information to user 2, step 360. Further, upon receipt of the payment, remote service 50 may provide an appropriate portion of the payment to the selected bidder.

In a further alternative embodiment, a construction project plan may be created for a desired construction service by allowing a potential consumer of a construction service, e.g. user 2 (FIG. 1), to complete a specification for a desired construction service where the specification comprises a bid request form. Remote service 50 (FIG. 1) may provide the specification to user 2 via an online source of specifications such as by using display 5 (FIG. 1).

User 2 (FIG. 1) completes and sends a completed specification to remote service 50 (FIG. 1) such as using display 5 (FIG. 1) via the Internet 100 (FIG. 1). Remote service 50 sends a generic bid request form, e.g. an anonymous version, to a predetermined plurality of suppliers or subcontractors 60 for bid, e.g. sending the specification by online means, by facsimile, by electronic mail, or by regular mail.

Remote service 50 (FIG. 1) then determines if any of the predetermined plurality of suppliers or subcontractors 60 (FIG. 1) has opted to provide a completed bid. If so, remote service 50 provides user 2 (FIG. 1) with an anonymous version of each of the received, completed bids after marking each bid up by a predetermined markup as well as selected bidder information.

Construction service providers 60 (FIG. 1) participating in the bid process receive detailed information gleaned from input from user 2 (FIG. 1). The information may also comprise a date and time to begin and end the auction for the requested products and/or services. In currently envisioned alternative embodiments, bidding is accomplished by one or more construction service providers 60 sending in one or more fixed bids responsive to a request for bid, one or more construction service providers 60 sending in one or more fixed bids responsive to a request for proposal, one or more bid responses from one or more construction service providers 60 which vary over a predetermined time frame during which the bidder may alter their bid either upward or downward, one or more responses from a plurality of construction service providers 60 which vary over a predetermined time frame during which each bidding construction service provider 60 may only alter their bid downward in response to a bid from another bidding construction service provider 60 (a “reverse auction”), or the like, or a combination thereof.

For example, for a reverse auction, construction service providers 60 (FIG. 1) may log into system 1 (FIG. 1), e.g. access one or more HTML or similar pages at server 50, at the designated timeframe to bid the price down. This auction style may be used by bidding construction service providers 60 to see a current bid amount at any time during the auction timeframe.

In an embodiment, remote service 50 (FIG. 1) may create a database and obtain data related to each provider 60 (FIG. 1), e.g. service or materials provider, who wishes to be contacted by remote service 50 concerning a submitted bid. The database may comprise information about construction service providers 60 and/or users 2. By way of example and not limitation, information regarding construction service providers 60 may comprise: name, address, phone, fax, contact, number of employees, years in business, a rating information such as from a BETTER BUSINESS BUREAU, feedback from other users 2 (such as on service, quality, responsiveness and problem resolution), bids submitted, current bids pending, how many bids construction service provider 60 has won, how many bidding processes has construction service provider 60 participated in, when was the last bid they submitted, and the like, or a combination thereof. Remote service 50 may submit a generic bid request, e.g. a generic bid request form, in the name of remote service 50 to one or more of the service providers 60 described in the database based on data present in the generic bid request. As used herein, “generic” may further comprise anonymous requests in that neither side may know the identity of the other. Remote service 50 may send the generic bid request form by electronic means such as e-mail or fax or by non-electronic means such as non-electronic mail or hand delivery.

As described herein above, user 2 (FIG. 1) may then select one of the providers 60 (FIG. 1) who submitted a bid. Remote service 50 (FIG. 1) may provide information regarding the selected bidder to user 2 such as by online means, electronic mail, regular mail, or facsimile.

It will be understood that various changes in the details, materials, and arrangements of the parts which have been described and illustrated above in order to explain the nature of this invention may be made by those skilled in the art without departing from the principle and scope of the invention as recited in the appended claims.

I claim:

1. A method of creating a construction project plan for a desired construction service, the method comprising:
a. allowing a potential consumer of a construction service to access a first region of a user interface displayed on a computer display, the first region defining a project plan definition region of the user interface;
b. using the user interface by the potential consumer to set a desired construction service context;
c. using the user interface by the potential consumer to complete bid request information;
d. sending the bid request information to a remote service;
e. sending of the bid request information by the remote service to a predetermined plurality of suppliers or subcontractors for bid;
f. determining by the remote service if any of the predetermined plurality of suppliers or subcontractors has opted to provide a completed bid;
g. for each of the predetermined plurality of suppliers or subcontractors who tenders a bid:
1) receiving the bid by remote service;
2) compiling of received bids by the remote service;
3) processing the compiled bids by the remote service;
4) sending by the remote service of at least one processed bid back to customer, a processed bid comprising information on a bidder;
5) allowing the consumer to select a bid of the processed bids sent the consumer by the remote service;
6) submitting of an order by the customer through the remote service;
7) sending of a notification of the order to the selected bidder; and
8) providing by the remote service of selected bidder information to the customer.

2. The method of claim 1, wherein:
a. bid is at least one of (i) a fixed bid responsive to a request for bid, (ii) a fixed bid responsive to a request for proposal, (iii) a response which varies over a predetermined time frame during which the bidder may alter their bid either upward or downward, or (iv) one or more responses which vary over a predetermined time frame during which the bidder may alter their bid downward in response to a bid from another bidder.

3. The method of claim 1, further comprising:
a. using the user interface by the potential consumer to define a timeline, procedure and execution means for a project, the project comprising a desired construction service, the project associatable with the desired construction service context; and
b. using data from the timeline, advice, procedures, and architectural plans and architectural advice to complete a bid request form with bid request information.
C. using data from the timeline, advice, procedures, architectural plans and architectural advice; estimator advice, estimating programs, and other construction service advice or program to complete a bid request form with bid request information.

4. The method of claim 1, further comprising:
a. using a standard bidding request filled out and plans provided by at least one of (i) the user or (ii) an authorized designate of the user to complete the bid request form;
b. wherein the bid request information comprises at least one of (i) an electronically transmittable construction plan or (ii) a hard copy of a construction plan.

5. The method of claim 1, wherein:
a. the construction service comprises at least one construction related product, service, or material;
b. wherein the one construction related product, service, or material includes at least one of (i) Construction Financing, (ii) Mortgage Financing, (iii) construction, property, or life insurance, (iv) title insurance, (v) surveying, (vi) appraisals, (vii) construction materials, (viii) construction professionals, (ix) window products or accessories, (x) door products or accessories, (xi) electrical products or fixtures, (xii) plumbing products, accessories or fixtures, (xiii) appliances, (xiv) flooring products or accessories, (xv) wallcovering products or accessories, (xvi) window covering products or accessories, (xvii) pool products or accessories, (xviii) fountain products or accessories, or (xix) spa products or accessories, (xx) decks, (xxi) roofing products, (xxii) air conditioning and heating products, (xxiii) insulation products, (xxiii) landscaping products or accessories; (xxiv) foundation products; (xxv) concrete products; or (xxvi) general construction products, construction materials, construction professionals, or construction services.

6. The method of claim 1, wherein:
a. bidding comprises at least one of (i) an unlimited number of rounds of bidding or (ii) a predetermined number of rounds of bidding on one set of floor plans for a predetermined group of building materials.

7. The method of claim 1, further comprising:
a. displaying a predetermined initial display.

8. The method of claim 7 wherein:
a. the initial display comprises at least one of (i) a promotional message or (ii) a user selectable region to indicate acquiescence by the user to services provided by the site.

9. The method of claim 1, further comprising:
a. obtaining a preliminary payment from a user before offering services; and
b. paying by the remote service a payment to the selected bidder.

10. The method of claim 9 wherein:
a. a predetermined amount of information is provided to the customer without first having obtained the preliminary payment; and
b. the preliminary payment comprises at least one of (i) a payment for information, (ii) a payment to allow access to information concerning one or more suppliers of construction services for a predetermined area, or (iii) a payment for information to allow access to information concerning one or more suppliers of construction materials for a predetermined area.

11. The method of claim 10, wherein:
a. the predetermined area is related to the submitted bid; and
b. the information comprises at least one of (i) a name of a supplier of construction services, (ii) a business address of the supplier of construction services, (iii) company background of the supplier of construction services, (iv) client feedback related to the supplier of construction services, (v) feedback from other sources related to the supplier of construction services, (vi) a commercial business information bureau, (vii) a consumer service, or (viii) supplier information.

12. The method of claim 9 further comprising:
a. upon receipt of the payment, providing the user with at least one of (i) a unique project number, (ii) a password selection form, or (iii) a personal information submission form.

13. The method of claim 12 further comprising:
a. requiring the user to accept predetermined terms before proceeding, the predetermined terms comprising at least one of (i) an agreement to not disclose the information, information regarding a subcontractor, or information regarding materials vendors to anyone else, (ii) damages if they do disclose any such information, (ii) a release of liability, (iii) an agreement by the client that they shall follow recommended procedures and suggestions such as: never providing payments up front prior to when services are rendered; seeking multiple bids, checking multiple references, and ensuring all legal paperwork is filled out and signed prior to allowing subcontractors to begin work or prior to paying any subcontractors, or (iv) agreeing that the user should seek local legal representation to review all legal forms.

14. The method of claim 13, further comprising:
a. obtaining an agreement from the user that, if the user does not follow all procedures and recommendations and sign all paperwork, the user will hold the remote service harmless.

15. The method of claim 12, further comprising:
a. requiring a user to log on by using the project number and the password each time the user visits the remote service to access functionality available through the remove service; and
b. restricting access at the remote service based on the submitted bid.

16. The method of claim 12, further comprising:
a. providing a user who logged on with an estimator useful to estimate costs of construction.

17. The method of claim 12, further comprising:
a. providing a form to at least one of (1) a logged in user or (ii) an authorized, logged in designate of the user, the form useful to:
1) supply a predetermined specification for a commodity associated with the submitted bid;
2) supply predetermined construction detail specification associated with the submitted bid; and
3) submit the predetermined specification to the remote service.

18. The method of claim 9, wherein:
a. preliminary payment is obtained by at least one of (i) an electronic form of payment or (ii) a non-electronic form of payment.

19. The method of claim 1, further comprising:
a. creating a database;
b. obtaining data related to each service or materials provider who wishes to be contacted by the remote service concerning the submitted bid; and
c. submitting the generic bid request in the name of the remote service to one or more of the service providers in the database based on data present in the generic bid request.

20. The method of claim 1, further comprising at least one of:
a. marking up each bid by a predetermined amount;
b. retaining the marked up amount by the remote service upon selection of a bid by the consumer; or
c. providing a payment method that allows both the service or material provider and the remote service to track purchases of the user whereby the service providers and materials providers pay the remote service a commission for any products or services sold.

21. The method of claim 1, wherein:
a. sending the generic bid request form by at least one of (i) email, (ii) fax, (iii) non-electronic mail, or (iv) hand delivery.

22. The method of claim 1, wherein:
a. processed bids are sent without the names of the parties bidding back to customer; and
b. the information comprises at least one of (i) a number of years each bidder has been in business, (ii) a number of employees available to each bidder, (ii) a number of crews available from each bidder, (iii) reference information, (iv) answers to a predetermined Contractor's Questionnaire, or (v) prior customer feedback information on the vendors or service providers.

23. The method of claim 22, wherein:
a. the prior customer feedback information includes at least one of (i) the quality of the products or services provided, (ii) the punctuality of the vendors or service provider's employees, (iii) the professionalism of the vendors or service provider's employees, (iv) user rating of the value of the products or services provided.

24. The method of claim 1, wherein:
a. orders are submitted using at least one of (i) a credit card or (ii) a check.

25. The method of claim 24, further comprising:
a. tracking electronic orders and payments; and
b. payment of commission tracked vendors and suppliers.

26. The method of claim 4, wherein:
a. the group of building materials comprises at least one of (i) lumber and building products, (ii) windows, (iii) plumbing materials, (iv) plumbing fixtures, (v) electrical materials, (vi) electrical fixtures, (vii) doors, (viii) hardware, (ix) roofing materials, (x) insulation materials, (xi) flooring, (xii) wall covering, (xiii) cabinet counter tops, (xiv) pools, (xv) spas, (xvi) fountains, (xvii) landscaping, (xvii) decks, (xviii) foundation materials, or (xix) concrete materials;
b. wherein lumber and building products comprise at least one of (i) plywood, (ii) oriented strand board, (iii) drywall, (iv) trim or cabinet wood, (v) cabinets, or (vi) molding.

27. A method of creating a construction project plan for a desired construction service, the method comprising:
a. allowing a potential consumer of a construction service to complete a specification for a desired construction service, the specification comprising a bid request form;
b. sending the specification to a remote service;
c. sending of a generic bid request form by the remote service to a predetermined plurality of suppliers or subcontractors for bid;
d. determination by the remote service if any of the predetermined plurality of suppliers or subcontractors has opted to provide a completed bid;
e. providing the potential consumer by the remote service with an anonymous version of each of the received, completed bids after marking each bid up by a predetermined markup;
f. providing by the remote service of selected bidder information to the potential consumer; and
g. providing compensation to the remote service by at least one of (i) the potential consumer or (ii) the predetermined plurality of suppliers or subcontractors for bid.

28. The method of claim 27, wherein:
a. sending the specification to a remote service is accomplished electronically.

29. The method of claim 28, further comprising:
a. providing the specification to the potential consumer via an online source of specifications;
b. providing the anonymous version by at least one of (i) online, (ii) electronic mail, (iii) regular mail, or (iv) facsimile; and
c. providing the selected bidder information to the potential consumer by at least one of (i) online, (ii) electronic mail, (iii) regular mail, or (iv) facsimile.

30. A user interface, comprising
a. a construction navigation page, further comprising a user selectable region to provide a user with access to a predetermined plurality of stages of construction, at least one of the user selectable regions providing a bid solicitation function, as well as a user selectable region to supply the user with access to information related to at least one of (i) a subcontractor, (ii) a materials vendor, (iii) a checklist, (iv) a warning, or (v) a “what is next” informational section on the construction timeline; and
b. a construction bid page, further comprising a user selectable region to allow a user to enter data related to a desired construction service, the construction bid page further comprising a user selectable submit bid region to allow a user to access a remote service and provide the remote service with the data related to the desired construction service.
